(19) United States
(12) Patent Application Publication
(10) Pub. No.: US 2005/0224401 A1
(43) Pub. Date: Oct. 13, 2005

(54) Filtration system with inter-filter flow controls

(76) Inventor: Dennis Chancellor, Gilbert, AZ (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/078,989

(22) Filed: Mar. 10, 2005

Related U.S. Application Data
(60) Provisional application No. 60/552,292, filed on Mar. 10, 2004.

(51) Int. Cl. C02F 1/00

(52) U.S. Cl. 210/143

(57) ABSTRACT

An improved filtration system monitors and controls inter-filter feed that flows from an upstream filter in a downstream filter.

This application claims the benefit of U.S. provisional application No. 60/552292 filed on Mar. 10, 2004 incorporated herein by reference in its entirety.

### FIELD OF THE INVENTION

The field of the invention is filtration systems.

### BACKGROUND OF THE INVENTION

Filtration systems that use a plurality of serially arranged filters are fraught with inefficiencies over time. Such inefficiencies are generally caused by excessively contaminated feed flowing into the downstream filters. The contaminated feed comes from the upstream filters and flows into the downstream filters becoming more contaminated as it passes through successive downstream filters. Note that the clean feed or permeate typically exits the system without flowing into subsequent downstream filters. Thus, the downstream filters of a multi-filter system are likely to operate inefficiently at least as compared to filters further upstream.

In order to address some of these inefficiencies, systems have been developed introducing fresh fluid feed downstream. The fresh fluid feed mixes with the contaminated or waste fluid to dilute the concentration of contaminated fluid going into the downstream filters. While such systems have proven to be somewhat effective in increasing the efficiencies of downstream filters, there is a need for methods and devices that can improve the efficiency.

### SUMMARY OF THE INVENTION

The present invention provides an improved filtration system for a multi-filter system having an upstream filter and a downstream filter disposed serially in a housing. The improvement comprises a monitor that monitors a condition of inter-filter fluid that passes from an upstream filter to a downstream filter.

In another aspect, methods of filtering fluid feed in a multi-filter system include the step of monitoring a condition of inter-filter fluid that flows from an upstream filter to a downstream filter.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a cross sectional view of an improved filtration system.

FIG. 2 is a cross sectional view of an alternative improved filtration system.

### DETAILED DESCRIPTION

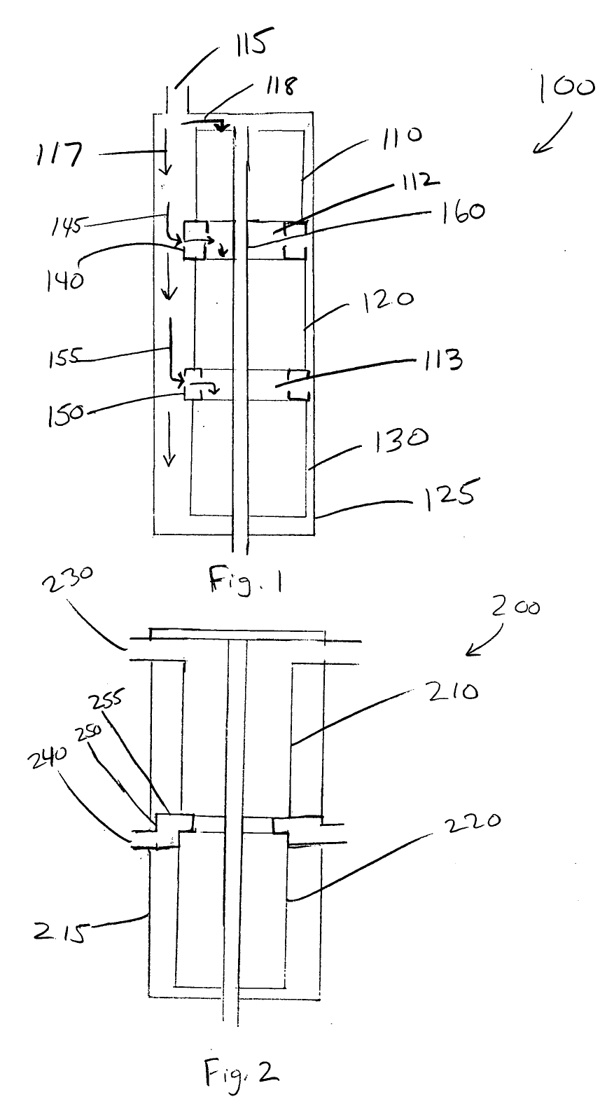

Referring first to FIG. 1, a filtration system 100 generally comprises an upstream filter (i.e. an annular membrane) 110 disposed upstream of a downstream filter 130, both filters being disposed within a housing 125. The system 100 also comprises monitors 140 and 150.

Fluid feed enters the system through inlet 115 and flows down along path 117 and along path 118 into the upstream filter 110. Fluid feed that does not enter the upstream filter may enter the inter-filter area 112 along path 145. Path 145 leads to monitor 140. Likewise feed entering inter-filter area 113 flows along path 155 and in doing so, the feed enters monitor 150.

Monitors 140 and 150 are positioned such that they can monitor inter-filter fluid (i.e. feed residing in the inter-filter area)for particular conditions. Among the conditions that can be monitored are pressure, salinity, particulate content, flow rate, and molarity. It should be appreciated that the monitors will be equipped with components that enable monitoring of inter-filter fluid including, for example, a pressure transducer, a salinity sensor, a particulate content sensor, a molarity sensor, a flow sensor, and so on.

Information captured by the monitors can be transmitted to remote devices (outside of the housing) in order to be interpreted and used to control the particular condition. For example, a remote computer could receive information concerning the salinity of the inter-filter feed and the computer could be programmed to actuate a solenoid that would open a valve allowing additional bypass fluid to enter the inter-filter area.

FIG. 2 shows a system 200 in which there is an inlet 240 to the housing 215 at an inter-filter level. Inlet 240 facilitates use of a controller 250 to allow additives or additional feed fluid to be admixed with inter-filter fluid in order to counter a condition detected by monitor 255.

It is contemplated that monitor 255 and controller 250 may be part of the same physical unit or may be separate, but in any case, information collected by the monitor 255 is transmitted to the controller 250 so that the controller can use the information to control a condition of the inter-filter fluid.

Methods of filtering fluid feed can include steps of monitoring inter-filter fluid, transmitting monitoring information to a controller, and controlling a condition of the inter-filter fluid by allowing admixing of bypass feed and/or additives.

Thus, specific embodiments and applications of a filtration system with inter-filter flow controls has been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. An improved filtration system having a housing that houses an upstream filter and a downstream filter, disposed such that at least some inter-filter fluid passes into the downstream filter, the improvement comprising a monitor that monitors a condition of the inter-filter fluid.

2. The system of claim 1, wherein the monitor comprises a pressure transducer.

3. The system of claim 1, wherein the monitor comprises a salinity sensor.

4. The system of claim 1, wherein the monitor comprises a particulate content sensor.

5. The system of claim 1, wherein the monitor comprises a molarity sensor.

6. The system of claim 1 wherein the monitor comprises a flow sensor.

7. The system of claim 1, further comprising a controller that alters the condition of the inter-filter fluid.

8. The system of claim 7, wherein the controller alters the condition of the fluid by admixing at least some bypass fluid into the inter-filter fluid.

9. The system of claim 7, wherein the controller comprises a valve.

10. The system of claim 7, wherein the controller alters the condition of the fluid by admixing an additive to the inter-filter fluid.
